(19) United States
(12) Patent Application Publication
(10) Pub. No.: US 2026/0314518 A1
(43) Pub. Date: Oct. 15, 2026

(54) THREE-DIMENSIONAL STEERING OF WHEELED MACHINES MOVING OVER AN NON-EVEN SURFACE

(71) Applicant: Topcon Positioning Systems, Inc., Livermore, CA (US)

(72) Inventors: Lev Borisovich RAPOPORT, Moscow (RU); Mikhail Yurievich SHAVIN, Dolgoprudy (RU); Alexey Anatolievich GENERALOV, Cheboksary (RU); Ivan Giovanni DI FEDERICO, Argenta (IT)

(73) Assignee: Topcon Positioning Systems, Inc., Livermore, CA (US)

(21) Appl. No.: 19/484,386

(22) PCT Filed: Jun. 6, 2023
(86) PCT No.: PCT/RU2023/000174

§ 371 Date: Nov. 14, 2025

(51) Int. Cl. A01B 69/04; G01S 19/47; G01S 19/53; G05D 1/248; G05D 105/15; G05D 111/50

(52) U.S. Cl. CPC A01B 69/008; G01S 19/47; G01S 19/53; G05D 1/248; G05D 2105/15; G05D 2111/52

(57) ABSTRACT

Precision agriculture makes use of high-accuracy navigation, attitude determination, and obstacle detection methods to save resources and to obtain better results. The collected machine position and attitude, and obstacle location data can be effectively employed to synthesize control algorithms for autonomous agricultural machines. These algorithms are applied for coverage path planning, route planning, motion stabilization along the specified paths, obstacle avoidance, and ensuring guaranteed behavior.

### FIELD OF THE INVENTION

The present disclosure relates generally to methods and apparatuses for operating autonomous machines and, in particular, to methods for steering wheeled agricultural machines over a non-even surface.

### BACKGROUND

The use of agricultural machines for growing crops has allowed for increased efficiency and output. An operator generally controls the movement of the machine and its implements. However, operators must be experienced in order to control operation of the machine in an efficient manner. This experience is generally gained through trial and error over time. Inexperienced operators often control operation of the machine in an inefficient manner which results in lost time and possible crop damage. What is needed is a way to efficiently control machines regardless of operator experience so that they operate in an efficient manner.

### SUMMARY

A method for steering an agricultural machine includes the steps of receiving location data from a GNSS receiver and receiving inertial data from a plurality of inertial sensors. An instantaneous curvature of the steering of the agricultural machine is determined based on the location data, the inertial data, an angle between a direction of the agricultural machine's movement and a tangent to a target path at a point closest to the agricultural machine, a path parameter, a function of the target path with respect to the path parameter, and a signed distance of a center of a rear axis of the agricultural machine to the target path. The signed distance has a positive sign when the agricultural machine is on one side of the target path and has a negative sign when the agricultural machine is on the other side of the target path. The agricultural machine is steered based on the determined instantaneous curvature of the steering of the agricultural machine.

In one embodiment, the instantaneous curvature of the steering of the agricultural machine is determined using the equation:

$$u = \frac{- 3 λ {z}^{′} - 3 {λ}^{2} z - {λ}^{3} \int zd ξ - P}{cos ψ} .$$

where Ψ is the angle between the direction of the agricultural machine's movement and the tangent to the target path at the point closest to the agricultural machine, ξ is a path parameter, z is a signed distance of the center of the rear axis of the agricultural machine to the target path and has a positive sign if the agricultural machine is on the one side of the target path and has a negative sign if the agricultural machine is on the other side of the target path, P is the function of the target path with respect to the path parameter, and z′=sin Ψ, the location data and inertial data used to determine Ψ, ξ, z, and P.

In one embodiment, the GNSS receiver receives GNSS satellite signals from at least one antenna, wherein an agricultural machine attitude estimation is corrected based on measurements of the agricultural machine's instantaneous velocity according to the relationship:

\dot{r}=R(v00)^{T}

where r is determined by a control action on the drives of the agricultural machine's wheels and the attitude of the agricultural machine's body.

In one embodiment, the GNSS receiver receives GNSS satellite signals from at least three antennas, wherein an agricultural machine attitude estimation is corrected based on measurements of vectors from one of the three antennas to the rest of the antennas, based on the relationship

b_{calib,i}=Rb_{mes,i},i=1,2

where b_{calib,i}, i=1,2 are two baselines expressed in the agricultural machine's body coordinate frame, which are determined based on the calibration procedure, and b_{mes,i}, i=1,2 are two instantly measured baselines.

In one embodiment, an initial agricultural machine attitude is determined using a calibration maneuver, wherein the agricultural machine attitude estimation is further based on the initial agricultural machine attitude.

In one embodiment, the calibration maneuver comprises moving the agricultural machine in a known direction of movement.

In one embodiment, the instantaneous curvature of the steering of the agricultural machine is determined using the equation:

\tilde{δ}=δ+βΠ(X)

where δ is the norm of lateral deviation, β is the positive scale factor, and Π(X) is the potential generated by a whole point cloud.

An apparatus includes a plurality of antennas, a GNSS receiver receiving signals from the plurality of antennas, and a plurality of inertial sensors. The apparatus also includes a controller configured to receive location data from the GNSS receiver and inertial data from the plurality of inertial sensors and perform the method for steering an agricultural machine described herein.

### BRIEF DESCRIPTION OF THE DRAWINGS

FIG. 1 shows an agricultural machine configured according to one embodiment;

FIG. 2 shows a body frame of a machine following a trajectory according to one embodiment;

FIG. 3A shows a point cloud generated by a 2D LIDAR according to one embodiment;

FIG. 3B shows an artificial potential according to one embodiment generated based on the point cloud shown in FIG. 3A; and

FIG. 4 shows a flow chart of a method according to one embodiment;

FIG. 5 shows a high-level block diagram of a computer according to one embodiment.

### DETAILED DESCRIPTION

The use of agricultural machines has allowed humanity to obtain crops (e.g. food) while reducing production expenses. In precision agriculture, high accuracy navigation systems are used to improve crop cultivation techniques which produce better results while saving resources, such as cultivation areas and operation time. Agricultural machines equipped with Global Navigation Satellite (GNSS) receivers to provide location data and other sensors to provide additional data can be used for mapping crops, monitoring crop yield, differential fertilization and pesticide spraying, and harvesting crops.

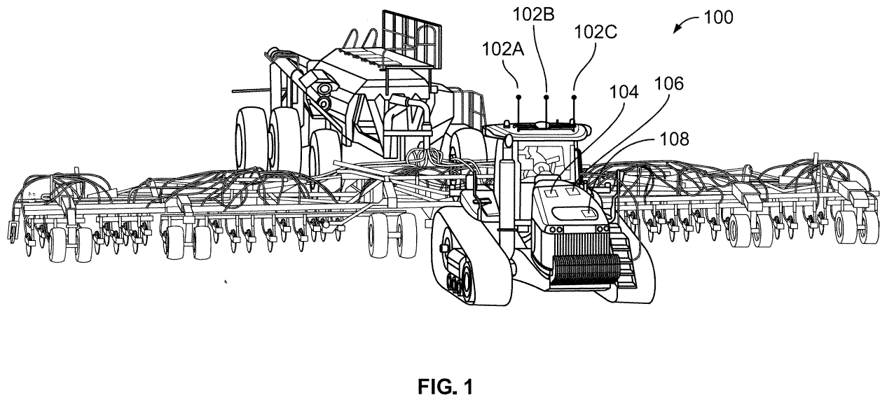

In the present disclosure, mathematical formulations of a motion control problem for autonomous wheeled machines, such as agricultural machine 100 shown in FIG. 1, are described as applied to precision agriculture. Machine 100 is shown having three antennas 102A, 102B, 102C for receiving GNSS satellite signals. It should be noted that although machine 100 is shown having three antennas, machine 100 can have one or more antennas in various embodiments. Antennas 102A, 102B, 102C are in communication with GNSS receiver 104 which determines location data based on the signals received by the antennas. GNSS receiver 104 is in communication with controller 106 which controls operation of one or more systems or components of machine 100. In one embodiment, controller 106 also receives inertial data from a plurality of inertial sensors 108. Inertial data can be used to augment GNSS location data and/or to allow for location determination using various techniques, such as dead reckoning. In one embodiment, controller 106 is used to perform the methods, calculations, and operations described herein.

In one embodiment, an agricultural field is initially divided into substantial parallel paths. Then, a route for agricultural machines to travel is planned. As each of the agricultural machines travels along its route, path stabilization, obstacle detection, and methods for ensuring the desired behavior are performed. In one embodiment, pre-existing non-moving (i.e., static) obstacles are considered during the route planning step and new non-moving obstacles are accounted for by the agricultural machine control system while the machine is in motion. In one embodiment, real time kinematic (RTK) positioning methods using a reference station can be utilized to provide centimeter accuracy for agricultural machine movement and movement of tools attached to or associated with the agricultural machine.

Although the general principals described herein can be applied to different types of vehicle motion systems, two types of wheeled agricultural machines are described herein in connection with the motion control problem for autonomous wheeled vehicles. Specifically, a wheeled agricultural machine having an Ackerman steering mechanism and a wheeled agricultural machine have differential rear wheel drive. For wheeled agricultural machines having the Ackerman steering mechanism the machine is rotated by the front wheels during motion and the wheel rotation limitation also limits the normal curvature u (projection of the curvature vector on the normal to the tangent plane) of the motion path:

$$‖ u ‖ \leq \frac{tg {α}_{max}}{L} \qquad ( 1 )$$

where αₘₐₓ is the maximal front wheel rotation angle, and L is the distance between the front and rear axles of the wheeled machine. If there are two front wheels, their rotation angles can be different, and then αₘₐₓ is the effective maximal rotation angle. Equation 1 acts as a constraint in planning the route of a wheeled agricultural machine. The violation of that constraint during the path planning leads to unrealizable paths. For agricultural machines with differential rear wheel drive that can turn on the spot, the constraint of Equation 1 need not be met.

For an agricultural machine having a one-antenna receiver, the machine attitude can be accurately determined if no cross-track slippage is assumed. This is referred to as a non-holonomic constraint. Generally, when machines operate on significantly uneven fields and cross-track slippage is inevitable, a two- or even three-antenna navigation receiver should be used. The larger the antenna baseline, the more accurate the attitude estimation. In one embodiment, the attitude data are additionally smoothed with the extended Kalman filter (EKF) or other filtering methods fusing data from GNSS receiver (e.g., GNSS receiver 104 of FIG.1) and strapdown inertial navigation systems (SINS) contained in the machine equipment.

In one embodiment, autonomous operation of the agricultural machine is performed using Light Detection and Ranging (LIDAR) and an optical stereo camera for generating a cloud of points received from the obstacles met on the machine path. However, the LIDAR and optical stereo camera data may not be considered at the path planning step. The data from additional sensors installed in different parts of the machine are fused into a common local obstacle map that takes the machine attitude into account. Based on these data, a generalized artificial potential is calculated, which synthesizes an artificial repulsive force modifying earlier synthesized steering and speed control to avoid collision with an obstacle. During movement of the agricultural machine, a control algorithm analyzes if the machine state should operate in an attraction domain, where path stabilization is possible.

Machine motion stabilization on the planned paths is described. Next, the estimation of attraction domains and obstacle avoidance are described. Lastly, navigation equipment used according to one embodiment is described.

Assuming the paths have been planned, the curvilinear paths are followed with high accuracy, often centimeter accuracy. In order to synthesize the control law according to one embodiment, it is needed to describe the machine kinematic scheme by the system of differential equations and to formulate the control objective as an algebraic relationship. The control objective can be zero lateral and angular deviation from the desired path. In one embodiment, some known methods for nonlinear systems control synthesis such as feedback linearization can be applied. The controller can be formally synthesized using algebraic techniques. The application of this method to the wheeled machine with Ackerman front wheel steering mechanism is described below.

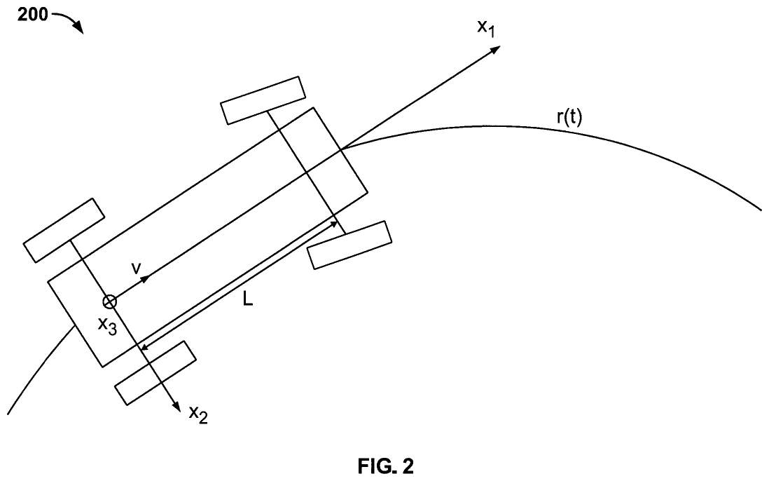

FIG. 2 shows a body frame of a machine having Ackerman front wheel steering and following a trajectory according to one embodiment. Let X∈R³ be the position of the target point in WGS-84, C be the rotation matrix from the BF to WGS-84. The origin of the BF is in the operating point. Its first axis is directed forward along the platform central line, the second axis is in the platform plane and is orthogonal to the first axis. The third axis points down orthogonally to the first two axes, complementing them to the right-hand frame, as shown in schematic 200 of FIG. 2. The vectors are considered to be the columns, and symbol T below denotes the transposition. Let the operating point be located in the middle of the machine rear axle. The velocity vector of the operating point in BF and WGS-84 is given by

$${V}_{B F} = ( \begin{matrix}V \\ 0 \\ 0\end{matrix} ) , V = {CV}_{B F} , \qquad ( 2 )$$

(no index means that the vector belongs to WGS-84), where v is the absolute magnitude of the linear velocity of the operating point. For simplicity, v is considered to be constant. Let e=(1,0,0)^{T}. Then the motion equations are given by

\dot{X}=vCe,Ċ=CΩ (3)

where

$$Ω = [ \begin{matrix}0 & - {ω}_{3} & {ω}_{2} \\ {ω}_{3} & 0 & - {ω}_{1} \\ - {ω}_{2} & {ω}_{1} & 0\end{matrix} ] , ω = ( \begin{matrix}{ω}_{1} \\ {ω}_{2} \\ {ω}_{3}\end{matrix} ) . \qquad ( 4 )$$

where ω is the angular velocity vector in BF measured by the gyroscope fixed on the platform. The third component ω₃ is also expressed via the linear velocity and instantaneous curvature of the trajectory described by the operating point in the plane tangent to the field surface and coinciding with the platform plane:

$${ω}_{3} = vu , u = \frac{tan α}{L} \qquad ( 5 )$$

In one embodiment, the machine travels on an a priori unknown surface. It is assumed for simplicity that the machine moves without any slippage, meaning that all the four wheels touch the surface simultaneously and roll without sliding. Then, the motion equations in the form of equation (6) can be used. This idealization can be realistic if the machine linear dimensions are negligibly small compared to the inverse maximum surface curvature. Let the path (trajectory determined at the machine route planning step) be given by p(s), where s is the path parameter. The function p(s) is considered to be twice continuously differentiable, which holds for the homogeneous cubic B-spline. The path parameter can have no dimension or the dimension of the path length. Distance from the point X to the path p(s) is given by

∥Δ∥,Δ=X−p(s*) (6)

where p(s*) is the path point, closest to X, ∥⋅∥ is the vector Euclidian norm. Assume that s* is unambiguously defined, i.e., minimum ∥X−p(s)∥ in s is achieved in the only point. Denote

$${p}^{′} ( s ) = \frac{d}{d s} p ( s ) , {p}^{″} ( s ) = \frac{{d}^{2}}{d {s}^{2}} p ( s ) .$$

Then s* is found using the equation

Δ^{T}p′(s)=(X−p(s))^{T}p′(s)=0. (7)

Differentiation of the last equation with respect to time yields \dot{X}^{T}p′+X^{T}p″\dot{s}−∥p′∥²\dot{s}−p^{T}p″\dot{s}=0, which, with account for (3), results in

$${\dot{s}}^{*} = \frac{{ve}^{T} {C}^{T} {p}^{′}}{{‖ {p}^{′} ‖}^{2} - {Δ}^{T} {p}^{″}} \qquad ( 8 )$$

It should be noted that all differentiations, equation solutions, and simplifications can be made using algebraic techniques. The relationship of equation (8) is calculated at the point s*. The symbol of dependence on s is omitted.

Denote δ=∥Δ∥=\sqrt{ΔTΔ}. Synthesize the control by feedback linearization method so that the norm of lateral deviation δ of the operating point X from the preset path exponentially decrease with the desired rate e^{-λt}. To do it, calculate \dot{δ} and \ddot{δ} (the systems of equations (3), (4) have a relative degree 2). We have

$$\dot{δ} = \frac{{Δ}^{T} \dot{Δ}}{δ} = \frac{{Δ}^{T} ( {}_{v} Ce - {p}^{′} \dot{s} )}{δ}$$

accounting for equation (7), Δ^{T}p′=0 holds, and thus,

$$\dot{δ} = \frac{v {Δ}^{T} C e}{δ} . \qquad ( 9 )$$

Further, considering equation (3), (4), (9) yields

$$\ddot{δ} = \frac{v {Δ}^{T} Ce + v {Δ}^{T} C Ω e}{δ} - \frac{v {Δ}^{T} Ce}{{δ}^{2}} \dot{δ} = \frac{v ( {ve}^{T} {C}^{T} - \dot{s} {p}^{′ T} ) + Ce + v {Δ}^{T} C Ω e}{δ} - \frac{{\dot{δ}}^{2}}{δ} . \qquad ( 10 )$$

Note that C^{T} Δ is the lateral deviation Δ in BF. The third component of this vector is 0, since A vector lies in the plane tangent to the surface:

$${C}^{T} Δ = ( \begin{matrix}{Δ}_{BF , 1} \\ {Δ}_{BF , 2} \\ 0\end{matrix} ) . \qquad ( 11 )$$

Using the last equation and equation (4), equation (10) is rewritten as

$$\dot{δ} = \frac{{v}^{2} - v \dot{s} {p}^{′ T} C e + {v}^{2} u ( {Δ}_{B F , 2} )}{δ} - \frac{{\dot{δ}}^{2}}{δ} . \qquad ( 12 )$$

With consideration for equation (11), equation (9) takes the form

$$\dot{δ} = \frac{V {Δ}_{B F , 1}}{δ} \qquad ( 13 )$$

Following the feedback linearization method, the desired differential equation, which provides the exponential decrease of δ, then becomes

\ddot{δ}+2λ\dot{δ}+λ²δ=0 (14)

Substituting equations (12) and (13) results in an algebraic equation

$$\frac{{v}^{2} - v \dot{s} {p}^{T} C e + {v}^{2} u ( {Δ}_{B F , 2} )}{δ} - \frac{{\dot{δ}}^{2}}{δ} + 2 λ \frac{ν {Δ}_{BF , 1}}{δ} + {λ}^{2} δ = 0 \qquad ( 15 )$$

which is solved for u:

$${u}^{*} = \frac{- {λ}^{2} {δ}^{2} - 2 v λ {Δ}_{B F , 1} - {v}^{2} + v \dot{s} {p}^{T T} C e + {( \frac{v {Δ}_{B F , 1}}{δ} )}^{2}}{{v}^{2} {Δ}_{BF , 2}} \qquad ( 16 )$$

Owing to equation (1), control u is limited by ū. Define the saturation as follows:

$$s a {t}_{\overline{u}} ( u ) = \{ \begin{matrix}\overline{u} & for u > \overline{u} \\ u & for \vert uk \overline{u} \\ - \overline{u} & for u < - \overline{u}\end{matrix} \qquad ( 17 )$$

Finally, the control satisfying the constraint of equation (1) results:

u=sat_{ū}(u*). (18)

It has been shown how the control law according to one embodiment can be formally derived based on the machine motion model (13) and the formulated control objective. The path curvature required by the control law according to one embodiment is provided by the machine steering mechanism. Under low motion speed, which is typical of agricultural machines, the transient processes due to the gear dynamics barely affect the machine motion. Control (16) provides the exponentially decreasing δ, however, the additional constraint (18) can effectively cancel this property.

Considering the construction of guaranteed attraction domains ensures safe machine behavior. During motion of the machine, machine state belongs to these domains satisfying the preset geometric constraints. Agricultural machines come into contact with the inhabited environment, unexpected obstacles, and can cause harm due to hardware or software problems. Thus, while increasing the efficiency of industrial operation, these machines become a source of potential danger in case of improper operation.

One of the approaches to enhance the safety and predictability of the machine's behavior estimates the invariant domain in the phase space, to which the machine's phase trajectory belongs. If the motion is started inside the domain, it will continue inside the domain, since it is invariant. The invariant domain is simultaneously the attraction domain of the equilibrium state corresponding to the operating mode. For the motion equations described in the previous section, the operation mode corresponds to the equilibrium state δ=0,\dot{δ}=0 of the system of differential equations (14). The control constraints, i.e., substituting control equation (16) with equation (18) leads to the fact that the trajectories of the system in equations (3), (4), closed by control equation (18), no longer satisfy the linear differential equation (14). The closed system becomes nonlinear due to the nonlinearity of relationship of equation (18).

The standard approach for estimating the attraction domains of nonlinear dynamic systems uses Lyapunov functions V(z) of certain parametric classes. Here, z is the phase space vector obtained by substituting the variables. Using the Lyapunov function, the attraction domain is estimated as

Ω(α)={z:V(z)≤α} (19)

provided that the V time derivative is negative due to the system dynamics \dot{V}<0.

The constant α controls the size of the attraction domain. The larger is the constant, the wider is the domain. Thus, a set of domains Ω(α₁)⊂Ω(α₂)⊂Ω(α₃) c . . . is generated using a set of constants α₁<α₂<α₃< . . . . Each of the domains is invariant and guarantees attraction to the equilibrium state z=0 describing the motion along a path with zero lateral and angular deviations. The widest domain corresponds to the largest possible constant α. Identifiers (e.g., shades or colors) can be assigned to each constant value to be indicated on a display that can be located, for example, in a monitoring center where the operation of the machines are monitored. The widest domain is defined so that geometric constraints are not violated within it. As one of the constraints, the maximum possible deviation from the path can be taken, and as another constraint, the tangent of the angle between the machine central axis and the tangent to the path at the point p(s*). If the tangent of the angle is finite at the beginning of the motion, it will remain finite throughout the motion due to the boundedness of the domain Ω(α), and the machine will not be positioned perpendicular to the path neither follow the opposite direction. The boundedness of the attraction domain is ensured by taking a strictly positive definite function as the Lyapunov function, for example, a quadratic form with a positive definite matrix or the Lurie—Postnikov function. The proposed estimate is generated in the phase space (δ; δ).

The agricultural machines detect the obstacles using additional sensors such as LIDARs and stereo cameras, which generate the data on the obstacles in the sensor FOV in the form of point clouds.

Each i-th point of the cloud may be assumed to have coordinates Yᵢ in the BF. After conversion to WGS-84, we have \tilde{X}=CYᵢ (see the beginning of section III). The artificial potential generated by one point of the cloud can be defined in different ways, for example, as follows:

$${Π}_{i} ( X ) = \{ \begin{matrix}{( {r}_{min} - ‖ X - {\tilde{X}}_{i} ‖ )}^{2} , & ‖ X - {\tilde{X}}_{i} ‖ \leq {r}_{min} ; \\ 0 , & ‖ X - {\tilde{X}}_{i} ‖ > {r}_{min} .\end{matrix}$$

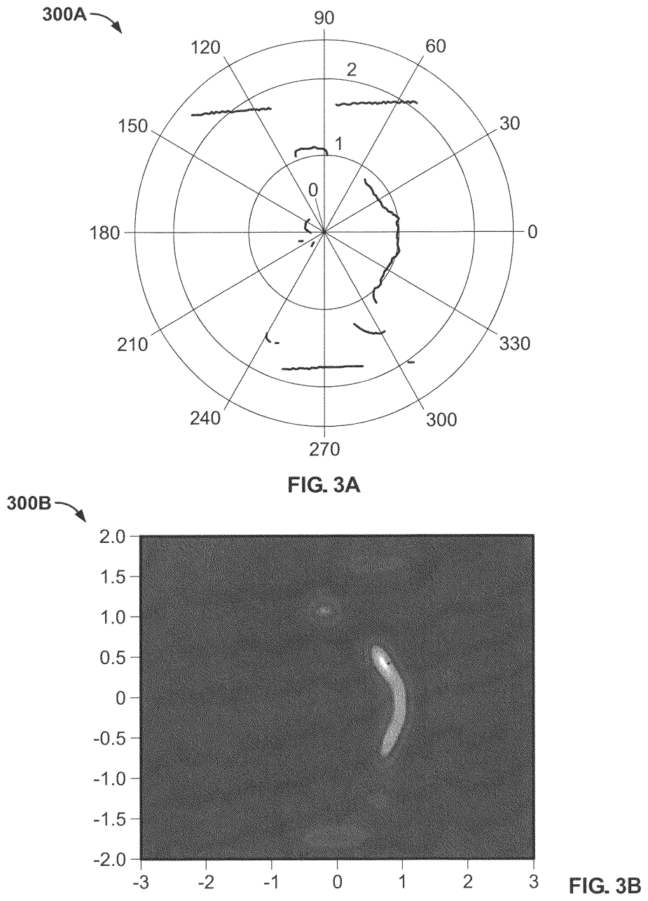

Then the potential generated by the whole cloud is defined as the sum of elementary potentials of all points: Π(X)=Σᵢ Πᵢ(X)
where rₘᵢₙ is the radius of the sensitivity circle beyond which the obstacles are ignored, X is the current position of the target point of the machine. FIG. 3A shows a point cloud 300A generated by a two-dimensional LIDAR, and FIG. 3B shows graph 300B of an artificial potential generated by the point cloud of FIG. 3A.

In one embodiment, a vector potential is determined for each obstacle using the equation Vᵢ(X)=Πᵢ(X)(X−\tilde{X}ᵢ)/∥X−\tilde{X}ᵢ∥. In the case of one obstacle, the total vector will be directed from that obstacle, and in the case of a complex configuration of several obstacles, the vector V(X)=Σᵢ Vᵢ(X), will be determined which can be used to produce a generalized method for positioning the agricultural machine and objects. That vector can be calculated for any position of the agricultural machine, thus the vector field is defined. As a result of this approach, the agricultural machine tends to go around obstacles by moving close to the path and the agricultural machine tends not to leave the field of action of the potential and the agricultural machine is directed perpendicular to the field gradient so that the potential does not increase, and the agricultural machine does not get closer to obstacles than desired.

In one embodiment, the control law is synthesized by the feedback linearization method using \tilde{δ} rather than δ described above:

\tilde{δ}=δ+β<eₓ,gradV> (20)

where β is the positive scale factor, eₓ is unit direction vector of the agricultural machine, <⋅,⋅> stands for a dot product. This method of calculating δ near obstacles allows the agricultural machine to track a specially curved trajectory relative to an original trajectory. Using the function of equation (20) to synthesize the control law provides obstacle avoidance capability.

For precise navigation and attitude determination, one to three GNSS antennas (e.g., antennas 102A, 102B, 102C of FIG. 1) are placed on the roof of the machine (e.g., machine 100 of FIG. 1), connected to a GNSS receiver (e.g., GNSS receiver 104 of FIG. 1). With three antennas, one of the receiver inputs is multifrequency. Generally, for reliable RTK operation, the first (master) input should receive GPS (L1, L2, L5), GLONASS (L1, L2), Galileo (E1, E5a), and Beidou (B1, B3) signals, i.e., be multifrequency. Two remaining (slave) inputs can be single-frequency and receive, for example, GPS L1, GLONASS L1, and Beidou B1 signals.

The navigation equipment also includes a strapdown inertial navigation system (SINS), which measures the angular velocities of the machine's body and linear accelerations of the SINS location point.

The GNSS receiver determines the position of the phase center of the master antenna and the Slave1 Master and Slave2—Master vectors (b₁ and b₂, respectively) in WGS-84. These vectors in BF are assumed to be known and equal to

$${b}_{1}^{0} and {b}_{2}^{0} .$$

Using SINS is optional, however, it improves the estimation of the motion parameters. GNSS-SINS integration to obtain the smoothed target point position and attitude C is performed with the extended Kalman filter, which is not described in this paper. It should be added that the following relationships are used in the measurement model for attitude determination for the case of three antennas:

$${b}_{1} = C {b}_{1}^{0} ,$$

$${b}_{2} = C {b}_{2}^{0} ,$$

and nonholonomic relation (2) is used for the case of one antenna. The attitude determination algorithm should be able to switch between one-, two- and three antenna modes in the case of losing the fixed solution when determining the inter-antenna vectors b₁ and b₂. The navigation aids allowing centimeter positioning accuracy makes it possible to solve the formulated control problems.

In one embodiment, a steering algorithm uses a feedback linearization approach to control dynamic systems, which is applied to a mathematical model of a wheeled machine, such as an agricultural machine, that can move on a non-even surface. The change in the position of the center of the rear axis of the machine r is determined by the control action on the drives of its wheels and the attitude of the machine's body, expressed by the rotation matrix

R:\dot{r}=R(v00)^{T}

Changing the orientation of the machine determines its angular velocity, which depends on the slope of the surface, and on the instantaneous curvature of its steering: u:w_{z}=vu

To synthesize the control law, the following variables are introduced: ξ a path parameter, and z is a signed distance of the center of the rear axis of the machine to a target path. z has a positive sign if the machine is on one side of the path, and has a negative sign if the machine is on the other side of the path.

To ensure exponential convergence of the machine trajectory to the target path, the control action on the wheel drives should provide a change in the parameter z according to the law

z″+3λz′+3λ²z+λ³∫zdξ=0

It follows from the machine motion model that

$${z}^{′} = sin ψ , and$$

$${z}^{″} = \frac{{cos}^{2} ψ}{z} ( 1 - \frac{{\vert {p}^{′} \vert}^{2}}{{\vert {p}^{′} \vert}^{2} - Δ \cdot {p}^{″}} ) + u cos ψ = P + u cos ψ ,$$

where Ψ is the angle between the direction of the machine's movement and the tangent to the path at the point closest to the machine, and p′ and p″ are derivatives of the function of the target path with respect to the parameter. Thus, we derive the control law

$$u = \frac{- 3 λ {z}^{′} - 3 {λ}^{2} z - {λ}^{3} \int zd ξ - P}{cos ψ} .$$

The resulting control law requires feedback on the position and the attitude of the machine. To provide feedback, in one embodiment, sensors and a state estimation algorithm based on the extended Kalman filter are used. These algorithms can work in two modes, where either three or a single GNSS antenna are used for navigation, while in both cases inertial sensors and a gyroscope are additionally installed. In the case of using three antennas, the attitude estimation correction uses the measurements of the vectors (baselines) from one of the antennas, called the master antenna, to the rest of the antennas, based on the relationship

b_{calib,i}=Rb_{mes,i},i=1,2,

where: b_{calib,i}, i=1,2 are two baselines expressed in the machine's body coordinate frame, which are determined based on the calibration procedure, b_{mes,i}, i=1,2 are two instantly measured baselines.

In the case of using a single antenna, the attitude estimation is corrected based on measurements of the machine's instant velocity according to the relationship

\dot{r}=R(v00)^{T}

expressing absence of the lateral slippage.

To initialize the initial attitude of the machine in single antenna mode, an initial calibration maneuver should be performed with a known direction of movement (forward or backward).

In one embodiment, the machine operation is controlled by a state machine using a set of states and rules for transitions between them are used. The list of states (which can be extended if necessary) comprises: INITIALIZATION, INITIALIZED, AUTOCTRLON, TOROUTEMANEUVER, ONROUTE, OBSTACLEAVOIDANCE, OBSTACLEFORCEDSTOP, ENDOFROUTE, SENSORTIMEOUTERROR, and ONROUTEERROR.

In the INITIALIZATION state, subsystems and sensors are checked; if the test is successful, the transition to the INITIALIZED state occurs; otherwise, the transition to one of the error states occurs. In the INITIALIZED state, an operator command is expected to switch to the AUTOCTRLON state. In this state, the maneuver parameters are calculated to the starting point of the target path and checking that the machine is within the allowable limits, then the transition to the TOROUTEMANEUVER state occurs, where the machine starts moving to the starting point of the path. If the starting point of the path is reached, the machine enters the ONROUTE state, where it tracks the target trajectory and performs its main task. After completing the target path, the machine enters the ENDOFROUTE state. During the movement, unforeseen obstacles may arise, then the machine, having detected them with the help of sensors, will switch to the OBSTACLEAVOIDANCE state, and in case of a dangerous approach, to the OBSTACLEFORCEDSTOP state. The current state of the machine can be determined using an indicator on the machine body, such as a color indicator.

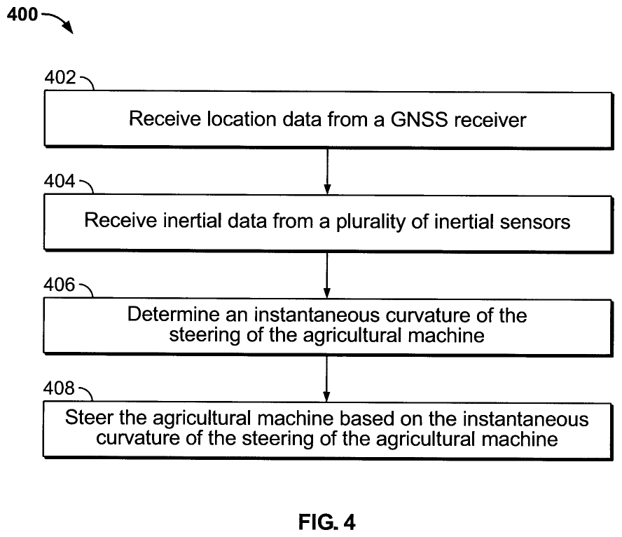

FIG. 4 shows a method 400 for steering an agricultural machine according to one embodiment. In one embodiment, controller 106 shown in FIG. 1 performs the steps of method 400. At step 402 location data is received from a GNSS receiver (e.g., GNSS receiver 104 of FIG. 1). At step 404, inertial data is received from a plurality of inertial sensors (e.g., plurality of inertial sensors 108 of FIG. 1). At step 406, an instantaneous curvature of the steering of the agricultural machine is determined. At step 408, the agricultural machine is steered based on the instantaneous curvature of the steering of the agricultural machine.

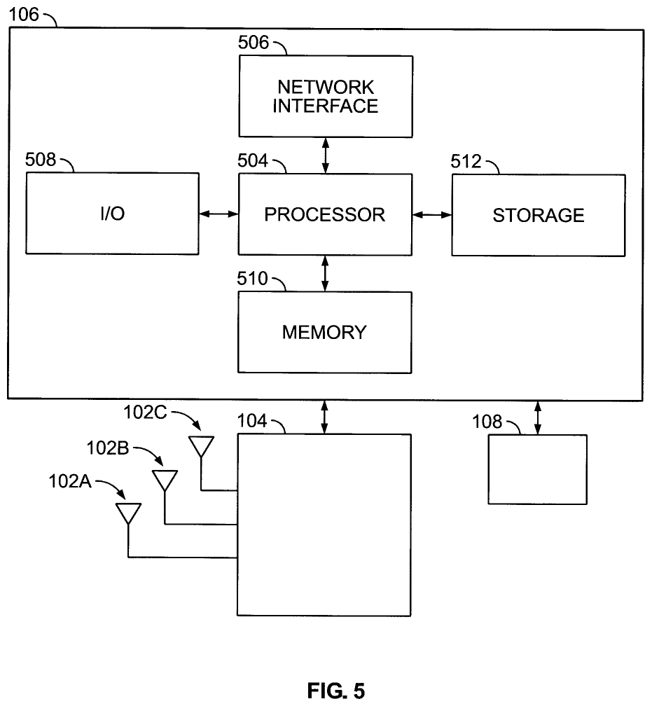

A schematic of components of machine 100 shown in FIG. 1 are shown in FIG. 5. Controller 106 is shown in communication with GNSS receiver 104 which receives GNSS satellite signals from antennas 102A, 102B, and 102C. Controller 106 is also in communication with plurality of inertial sensors 108. Controller 106 and the methods, calculations, and operations described herein can be implemented using components that form a computer. A high-level block diagram of the components of such a computer used to implement controller 106 is illustrated in FIG. 5. Controller 106 contains a processor 504 which controls the overall operation of the controller 106 by executing computer program instructions which define such operation. The computer program instructions may be stored in a storage device 512, or other computer readable medium (e.g., magnetic disk, CD ROM, etc.), and loaded into memory 510 when execution of the computer program instructions is desired. Thus, the methods, techniques, and calculations described herein can be defined by the computer program instructions stored in the memory 510 and/or storage 512 and controlled by the processor 504 executing the computer program instructions. For example, the computer program instructions can be implemented as computer executable code programmed by one skilled in the art to perform an algorithm defined by the methods, techniques, and calculations described herein. Accordingly, by executing the computer program instructions, the processor 504 executes an algorithm defined by the methods, techniques, and calculations described herein. Controller 106 also includes one or more network interfaces 506 for communicating with other devices via a network. Controller 106 also includes input/output devices 508 that enable user interaction with the computer 502 (e.g., display, keyboard, mouse, speakers, buttons, etc.) One skilled in the art will recognize that an implementation of a controller could contain other components as well, and that FIG. 5 is a high-level representation of some of the components of such a controller for illustrative purposes. GNSS receiver 104 could also be implemented using the components of a computer in a manner similar to that described above in connection with controller 106.

The foregoing Detailed Description is to be understood as being in every respect illustrative and exemplary, but not restrictive, and the scope of the inventive concept disclosed herein should be interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method for steering an agricultural machine, the method comprising:
receiving location data from a GNSS receiver;
receiving inertial data from a plurality of inertial sensors;
determining an instantaneous curvature of the steering of the agricultural machine based on the location data, the inertial data, an angle between a direction of the agricultural machine's movement and a tangent to a target path at a point closest to the agricultural machine, a path parameter, a function of the target path with respect to the path parameter, and a signed distance of a center of a rear axis of the agricultural machine to the target path, the signed distance having a positive sign when the agricultural machine is on one side of the target path and having a negative sign when the agricultural machine is on the other side of the target path; and
steering the agricultural machine based on the determined instantaneous curvature of the steering of the agricultural machine.

2. The method of claim 1, wherein the instantaneous curvature of the steering of the agricultural machine is determined using the equation:
$$u = \frac{- 3 λ {z}^{′} - 3 {λ}^{2} z - {λ}^{3} \int zd ξ - P}{cos ψ} .$$
where Ψ is the angle between the direction of the agricultural machine's movement and the tangent to the target path at the point closest to the agricultural machine, ξ is a path parameter, z is a signed distance of the center of the rear axis of the agricultural machine to the target path and has a positive sign if the agricultural machine is on the one side of the target path and has a negative sign if the agricultural machine is on the other side of the target path, P is the function of the target path with respect to the path parameter, and z′=sin Ψ, the location data and inertial data used to determine Ψ, ξ, z, and P.

3. The method of claim 2, wherein the GNSS receiver receives GNSS satellite signals from at least one antenna, wherein an agricultural machine attitude estimation is corrected based on measurements of the agricultural machine's instantaneous velocity according to the relationship:
\dot{r}=R(v00)^{T}
where r is determined by a control action on the drives of the agricultural machine's wheels and the attitude of the agricultural machine's body.

4. The method of claim 2, wherein the GNSS receiver receives GNSS satellite signals from at least three antennas, wherein an agricultural machine attitude estimation is corrected based on measurements of vectors from one of the three antennas to the rest of the antennas, based on the relationship
b_{calib,i}=Rb_{mes,i},i=1,2
where b_{calib,i}, i=1,2 are two baselines expressed in the agricultural machine's body coordinate frame, which are determined based on a calibration procedure, and b_{mes,i}, i=1,2 are two instantly measured baselines.

5. The method of claim 4, wherein an initial agricultural machine attitude is determined using a calibration maneuver, wherein the agricultural machine attitude estimation is further based on the initial agricultural machine attitude.

6. The method of claim 5, wherein the calibration maneuver comprises moving the agricultural machine in a known direction of movement.

7. The method of claim 1, wherein the instantaneous curvature of the steering of the agricultural machine is determined using the equation:
\tilde{δ}=δ+βΠ(X)
where δ is the norm of lateral deviation, β is the positive scale factor, and Π(X) is the potential generated by a whole point cloud.

8. An apparatus comprising:
a plurality of antennas;
a GNSS receiver receiving signals from the plurality of antennas;
a plurality of inertial sensors; and
a controller configured to receive location data from the GNSS receiver and inertial data from the plurality of inertial sensors and perform the method of claim 1 for steering an agricultural machine.

9. The apparatus of claim 8, wherein the instantaneous curvature of the steering of the agricultural machine is determined using the equation:
$$u = \frac{- 3 λ {z}^{′} - 3 {λ}^{2} z - {λ}^{3} \int zd ξ - P}{cos ψ}$$
where Ψ is the angle between the direction of the agricultural machine's movement and the tangent to the target path at the point closest to the agricultural machine, ξ is a path parameter, z is a signed distance of the center of the rear axis of the agricultural machine to the target path and has a positive sign if the agricultural machine is on the one side of the target path and has a negative sign if the agricultural machine is on the other side of the target path, P is the function of the target path with respect to the path parameter, and z′=sin Ψ, the location data and inertial data used to determine Ψ, ξ, z, and P.

10. The apparatus of claim 9, wherein the GNSS receiver receives GNSS satellite signals from at least one antenna, wherein an agricultural machine attitude estimation is corrected based on measurements of the agricultural machine's instantaneous velocity according to the relationship:
\dot{r}=R(v00)^{T}
where r is determined by a control action on the drives of the agricultural machine's wheels and the attitude of the agricultural machine's body.

11. The apparatus of claim 9, wherein the GNSS receiver receives GNSS satellite signals from at least three antennas, wherein an agricultural machine attitude estimation is corrected based on measurements of vectors from one of the three antennas to the rest of the antennas, based on the relationship
b_{calib,i}=Rb_{mes,i},i=1,2
where b_{calib,i}, i=1,2 are two baselines expressed in the agricultural machine's body coordinate frame, which are determined based on the calibration procedure, and b_{mes,i}, i=1,2 are two instantly measured baselines.

12. The apparatus of claim 11, wherein an initial agricultural machine attitude is determined using a calibration maneuver, wherein the agricultural machine attitude estimation is further based on the initial agricultural machine attitude.

13. The apparatus of claim 12, wherein the calibration maneuver comprises moving the agricultural machine in a known direction of movement.

14. The apparatus of claim 8, wherein the instantaneous curvature of the steering of the agricultural machine is determined using the equation:
\tilde{δ}=δ+βΠ(X)
where δ is the norm of lateral deviation, β is the positive scale factor, and Π(X) is the potential generated by a whole point cloud.
